(19) United States
(12) Patent Application Publication
(10) Pub. No.: US 2018/0018900 A1
(43) Pub. Date: Jan. 18, 2018

(54) System and Method for Monitoring a Style of Play

(71) Applicant: Under Armour, Inc., Baltimore, MD (US)

(72) Inventors: Mark Oleson, Baltimore, MD (US); F. Grant Kovach, Baltimore, MD (US); Nathan Dau, Baltimore, MD (US); Angela Nelligan, Baltimore, MD (US)

(21) Appl. No.: 15/211,357

(22) Filed: Jul. 15, 2016

(51) Int. Cl. G09B 19/00; G01P 11/00; G01P 3/42; G01C 22/00; A43B 5/00; G01P 15/00; A43B 3/00

(52) U.S. Cl. CPC G09B 19/0038; G01P 15/00; G01P 11/00; A43B 3/0005; G01C 22/006; A43B 5/00; G01P 3/42

(57) ABSTRACT

A system includes a shoe, a timer, a positioning component, a controlling component, a memory and a processing component. The timer establishes a time frame. The positioning component determines a first geodetic location of the shoe at a first time within the time frame and determines a second geodetic location of the shoe at a second time within the time frame. The controlling component is disposed at the shoe and generates activity data based on the first geodetic location, the second geodetic location and the time frame. The memory is disposed at the shoe and stores the activity data. The processing component retrieves the activity data from the memory and wirelessly transmits processed activity data based on the activity data. The positioning component further determines a first geodetic location total time corresponding to a total time the shoe is located at the first geodetic location within the time frame.

### BACKGROUND

The present invention generally relates to monitoring activity while playing basketball.

There exists a need for a device and method to monitor and view the activity of a basketball player.

### BRIEF SUMMARY OF THE DRAWINGS

The accompanying drawings, which are incorporated in and form a part of the specification, illustrate example embodiments and, together with the description, serve to explain the principles of the invention. In the drawings:

FIG. 1 illustrates a basketball player playing basketball while wearing an activity tracking shoe;

FIG. 2A illustrates communication between an activity tracking shoe and a mobile device;

FIG. 2B illustrates a block diagram of a mobile device;

FIG. 3 illustrates a block diagram of an activity tracking pod in accordance with aspects of the present invention;

FIGS. 4A-C illustrate basketball players practicing while wearing activity tracking shoes;

FIG. 5 illustrates positions on a basketball court included in the monitoring data in accordance with aspects of the present invention; and

FIG. 6 illustrates a method by which basketball activities are detected, generated, transmitted, and displayed.

### DETAILED DESCRIPTION

### Overview

A system includes a shoe, a timer, a positioning component, a controlling component, a memory and a processing component. The timer is disposed at the shoe and establishes a time frame. The positioning component is disposed at the shoe and determines a first geodetic location of the shoe at a first time within the time frame and determines a second geodetic location of the shoe at a second time within the time frame. The controlling component is disposed at the shoe and generates activity data based on the first geodetic location, the second geodetic location and the time frame. The memory is disposed at the shoe and stores the activity data. The processing component retrieves the activity data from the memory and wirelessly transmits processed activity data based on the activity data. The positioning component further determines a first geodetic location total time corresponding to a total time the shoe is located at the first geodetic location within the time frame.

### EXAMPLE EMBODIMENTS

One of the recent trends in fitness is using a wearable device to record data related to the activity a user is performing. The data can be downloaded directly to a receiving device, which can be a computer, smartphone, or other smart device, and the user can refer to the downloaded data to track his progress. A conventional wearable device may incorporate various sensors to determine activity levels. Non-limiting examples of such sensors include temperature sensors, pressure sensors, water sensors, moisture sensors, saline sensors, electric field sensors, current sensors, voltage sensors, impedance sensors, magnetic field sensors, accelerometers, altimeters, GPS sensors, magnetometers, optical sensors, and chemical sensors.

In team sports like basketball, it is important to understand not only the activity level of each player, but also the playing style of each player. Understanding the activity level and playing style of a player can help the coaches and player develop strategies and exercises for improvement on the court. Currently, this type of data can only be generated by installing many expensive cameras around a basketball court, which may be a significant barrier for those interested in acquiring basketball-related data. There exists a need for a smart wearable that can track a basketball player's activity level and playing style, and display the activity level and playing style.

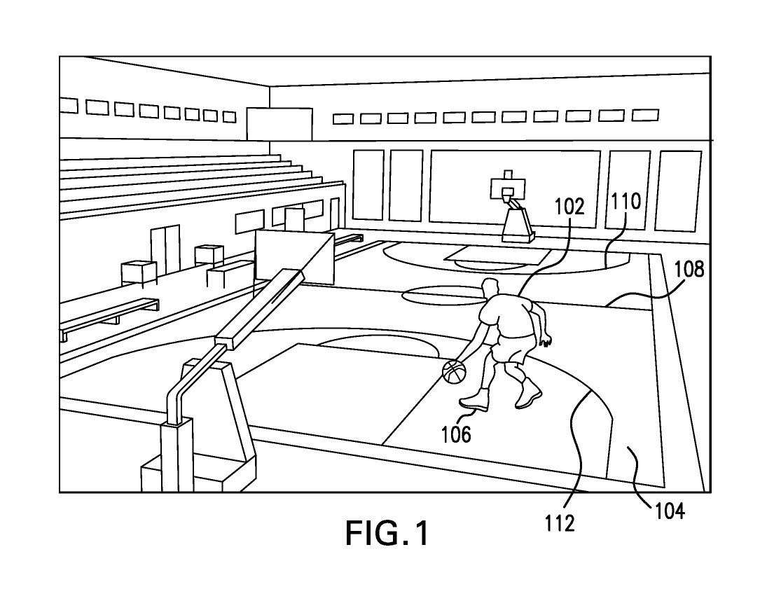

FIG. 1 illustrates a basketball player playing basketball while wearing an activity tracking shoe, in accordance with aspects of the present invention.

As shown in the figure, a player 102 is playing on a court 104 while wearing a shoe 106.

Court 104 includes half-court line 108, three-point line 110, and three-point line 112.

Player 102 may be practicing by himself, playing in a pickup game, or playing in an organized game. In any of these scenarios, shoe 106 will track the activity of player 102.

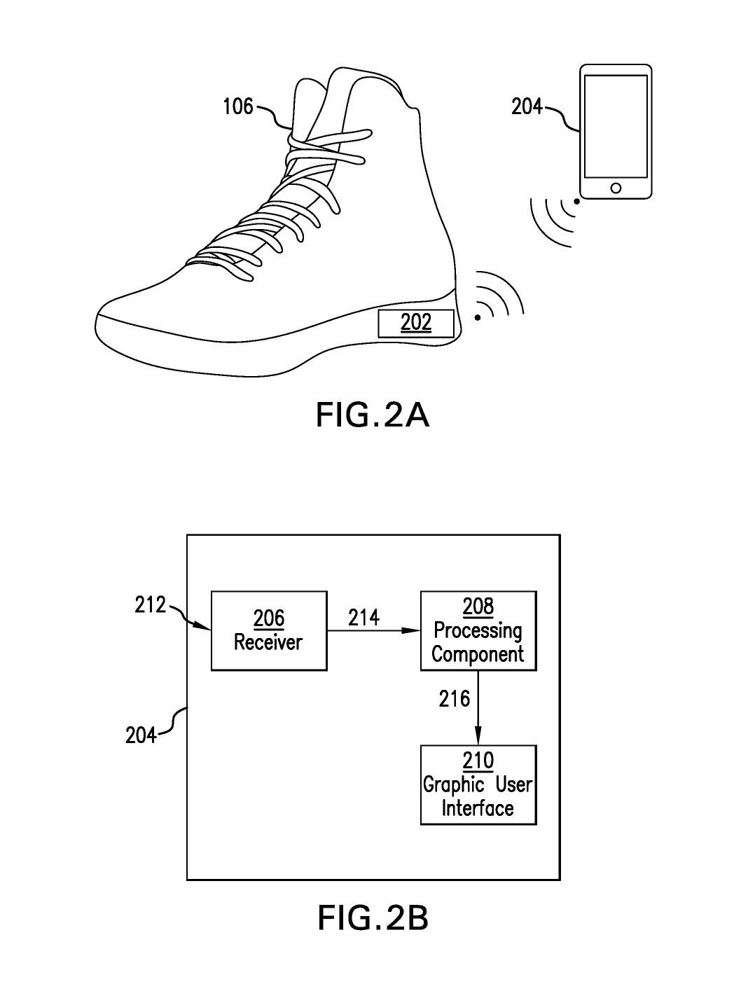

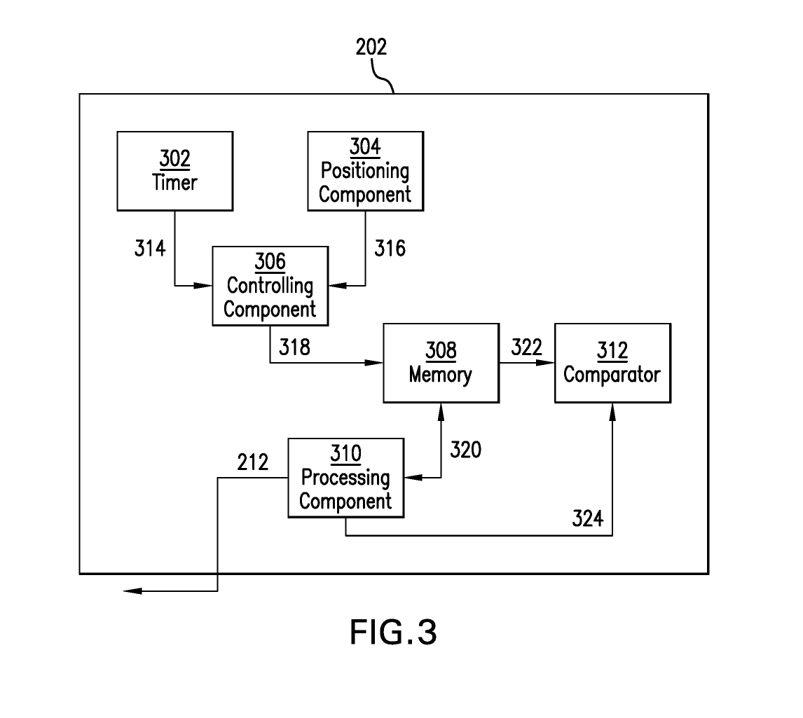

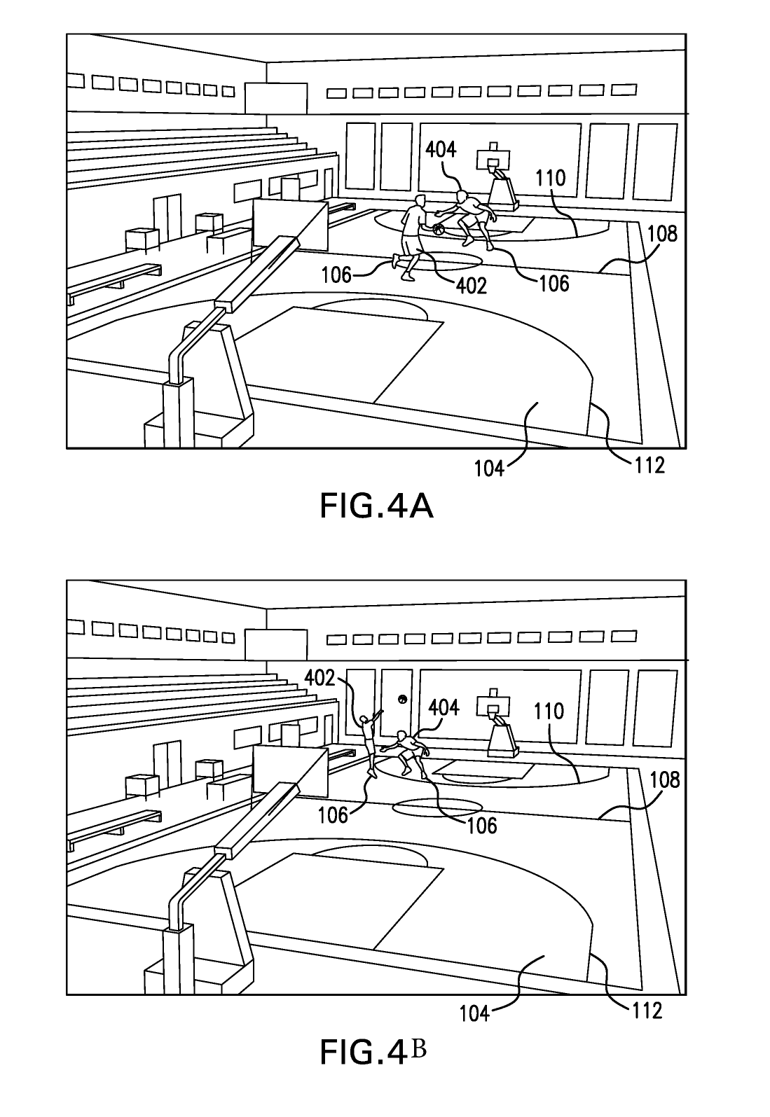

Shoe 106 is an activity tracking shoe that can track the activity of player 102 and communicate with another device to transmit the activity data. Shoe 106 may refer to a single shoe with activity tracking capabilities, but it may also refer to a pair of shoes with each shoe having activity tracking capabilities. Shoe 106 will be further described with reference to FIGS. 2-3.

FIG. 2A illustrates communication between an activity tracking shoe and a computing device.

As shown in the figure, shoe 106 includes a pod 202. Pod 202 communicates wirelessly with computing device 204.

Computing device 204 may be a cellular phone, a tablet computer, a laptop computer, or any other device capable of receiving and sending information.

Pod 202 may be any type of device or system arranged to detect, track, and store activity data.

Pod 202 and computing device 204 may communicate by any wireless means that can transmit data from pod 202 to computing device 204. Non-limiting examples of wireless means include Wi-Fi, Bluetooth, one or more cellular networks, or satellite.

FIG. 2B illustrates a block diagram of a computing device.

As shown in the figure, computing device 204 includes a receiver 206, a processing component 208, and a graphic user interface (GUI) 210.

In this example embodiment, receiver 206, processing component 208, and GUI 210 are shown as independent components. However, in some embodiments, at least two of receiver 206, processing component 208, and GUI 210 may be combined as a unitary device. Further, in some embodiments, at least one of receiver 206 and processing component 208 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Receiver 206 communicates with pod 202 via a communication channel 212 and with processing component 208 via a communication channel 214.

Receiver 206 may be any type of device or system that receives data from pod 202 and provides the data to processing component 208.

Processing component 208 communicates with receiver 206 via communication channel 214 and with GUI 210 via a communication channel 216.

Processing component 208 may be any type of device or system that receives data from receiver 206, manipulates the data, and provides the manipulated data to GUI 210.

GUI 210 communicates with processing component 208 via communication channel 216.

GUI 210 may be any type of device or system that can receive the manipulated data from processing component 208 and display the data to a user.

FIG. 3 illustrates a block diagram of an activity tracking pod in accordance with aspects of the present invention.

As shown in the figure, pod 202 includes a timer 302, a positioning component 304, a controlling component 306, a memory 308, a processing component 310, and a comparator 312.

In this example embodiment, timer 302, positioning component 304, controlling component 306, memory 308, processing component 310, and comparator 312 are shown as independent components. However, in some embodiments, at least two of timer 302, positioning component 304, controlling component 306, memory 308, processing component 310, and comparator 312 may be combined as a unitary device. Further, in some embodiments, at least one of timer 302, positioning component 304, controlling component 306, memory 308, processing component 310, and comparator 312 may be implemented as a computer having tangible computer-readable media for carrying or having computer-executable instructions or data structures stored thereon.

Timer 302 communicates with controlling component 306 via a communication channel 314.

Timer 302 may be any device or system that can establish a time frame during which a player's activity will be tracked, and provide that time frame to controlling component 306. Non-limiting examples of timers include electronic timers and timer software applications.

Positioning component 304 communicates with controlling component 306 via a communication channel 316.

Positioning component may be any device or system that determines a geodetic location of pod 202, and thus shoe 106, and provides the geodetic location data to controlling component 306. A non-limiting example of a positioning component includes a global positioning system (GPS).

Controlling component 306 communicates with timer 302 via a communication channel 314, with positioning component 304 via communication channel 316, and with memory 308 via a communication channel 318.

Controlling component 306 may be any device or system that generates data related to a player's activity based on the time frame and the geodetic location data.

Memory 308 communicates with controlling component 306 via communication channel 318, with processing component 310 via a communication channel 320, and with comparator 312 via a communication channel 322.

Memory 308 may be any device or system that stores the activity data generated by controlling component 306 and provides the activity data to processing component 310 and comparator 312. Non-limiting examples of memory include: physical storage and/or memory media such as RAM, ROM, EEPROM, CD-ROM or other optical disk storage, magnetic disk storage or other magnetic storage devices.

Memory 308 may also contain a priori data to which the activity data may be compared. A priori data may be data previously generated by measuring the activity levels of other players of various skill levels. Non-limiting examples of a priori data within memory 308 may include: total movement time, average velocity, maximum velocity, total distance traveled, maximum acceleration, total standing time, directional total movement time, directional average velocity, directional maximum velocity, directional total distance traveled, directional maximum acceleration, time in the air, ground contact time and combinations thereof.

Processing component 310 communicates with memory 308 via communication channel 320 and with comparator 312 via a communication channel 324.

Processing component 310 may be any type of device or system that receives activity data from memory 308 and compared activity data from comparator 312, and provides the activity data and compared activity data to computing device 204 via communication channel 212.

Comparator 312 may be any device or system that receives the activity data and a priori data from memory 308, compares the activity data to the a priori data, and generates a compared signal based on the comparison. Comparator 312 provides the compared signal to processing component 310.

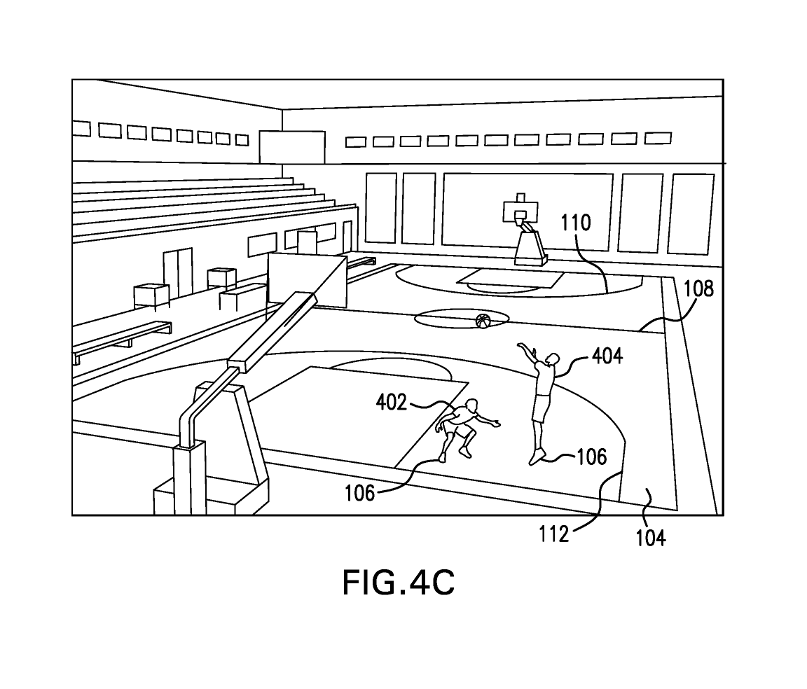

FIGS. 4A-C illustrate basketball players practicing while wearing activity tracking shoes.

As shown in the figures, a player 402 is playing a game of 1-on-1 with a player 404 during a team practice. Both players are wearing shoes that are similar to shoe 106.

As shown in FIG. 4A, player 402 is on offense and player 404 is on defense. In this example, player 402 is dribbling the ball slowly toward half court line 108 and player 404 is playing defense just outside of three-point line 110. Because player 404 is far from player 402, player 404 is stationary.

As shown in FIG. 4B, player 402 changes speed and dribbles quickly to the left side of court 104. Player 404 moves quickly both laterally and backward, moving inside three-point line 110 while playing defense. Player 402 shoots a three-point shot from behind three-point line 110 while player 404 is playing defense. In this example, if player 402 makes the shot then player 404 subsequently gets the ball on offense.

As shown in FIG. 4C, player 404 is now on offense and player 402 is on defense. In this example, player 404 dribbles slowly down the court until he reaches half-court line 108, then dribbles quickly to a spot inside of three-point line 112 and takes a two-point shot. Player 402 plays defense by matching speed with player 404, first moving slowly as player 404 dribbles slowly down the court, and then player 402 may shuffle his feet while moving laterally to stay close to player 404.

Throughout the sequence of FIGS. 4A-C, activity tracking shoe 106 worn by player 402 has been capturing data regarding the playing activity of player 402, and activity tracking shoe 106 worn by player 404 has been capturing data regarding the playing activity of player 404.

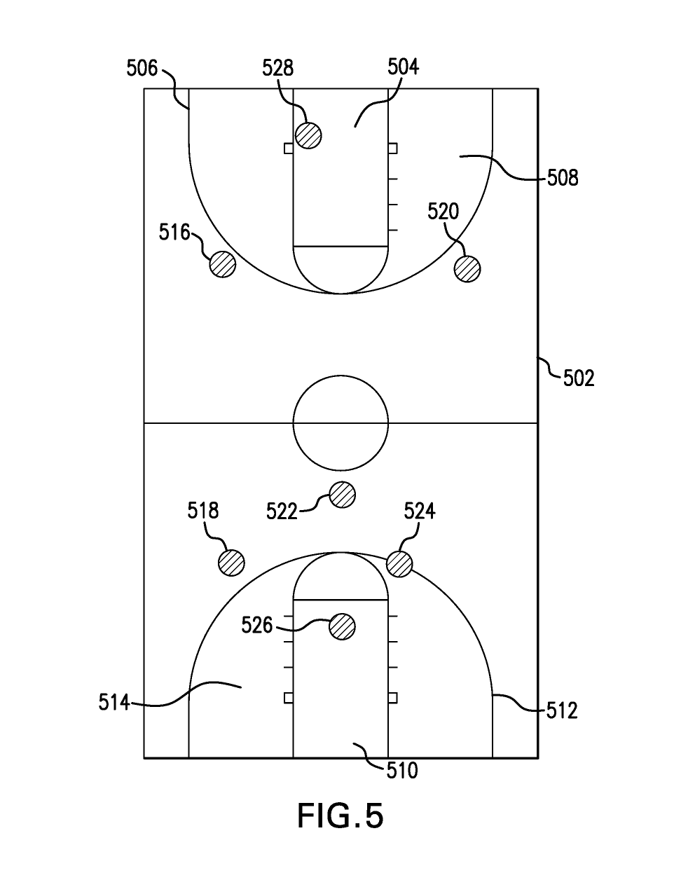

FIG. 5 illustrates positions on a basketball court included in the monitoring data in accordance with aspects of the present invention.

As shown in the figure, a court 502 includes a free throw lane 504, a three-point line 506, a two-point area 508, a free throw lane 510, a three-point line 512, a two-point area 514, a spot 516, a spot 518, a spot 520, a spot 522, a spot 524, a spot 526, and a spot 528.

Court 502 is a typical basketball court on which a player plays basketball. Spots 516-528 are areas on court 502 where a player may be at various times.

In this example, a player is playing in a game and his activity is being tracked by activity tracking shoe 106 (not shown). During one portion of the game, the player may dribble the ball slowly from spot 518 to spot 516, then pass the ball, make a jab step and cut quickly to spot 520 in an attempt to get open for a return pass. The player may receive a pass at spot 520 and proceed to jump in the air and shoot the ball.

While on defense during another portion of the game, the player may be guarding an opponent at spot 522, move quickly to spot 524 while guarding his opponent, and then move quickly again to spot 526 while guarding the opponent.

During yet another portion of the game, the player may set a screen at spot 524 for a teammate dribbling the ball at spot 522, and then after the teammate goes around the screen at spot 524, the player rolls toward the basket at spot 526 looking for a pass from his teammate.

During yet another portion of the game, the player may be posting up on offense at spot 528, and after he receives the ball he quickly spins into free throw lane 504 and shoots a layup.

During another portion of the game, the player may be playing press defense and trying to put heavy defensive pressure on his opponent at spot 518. His opponent may break the press and throw a deep pass to another opponent at spot 520, and the player may sprint as fast as he can to spot 528 to make sure no opponents can make an easy layup.

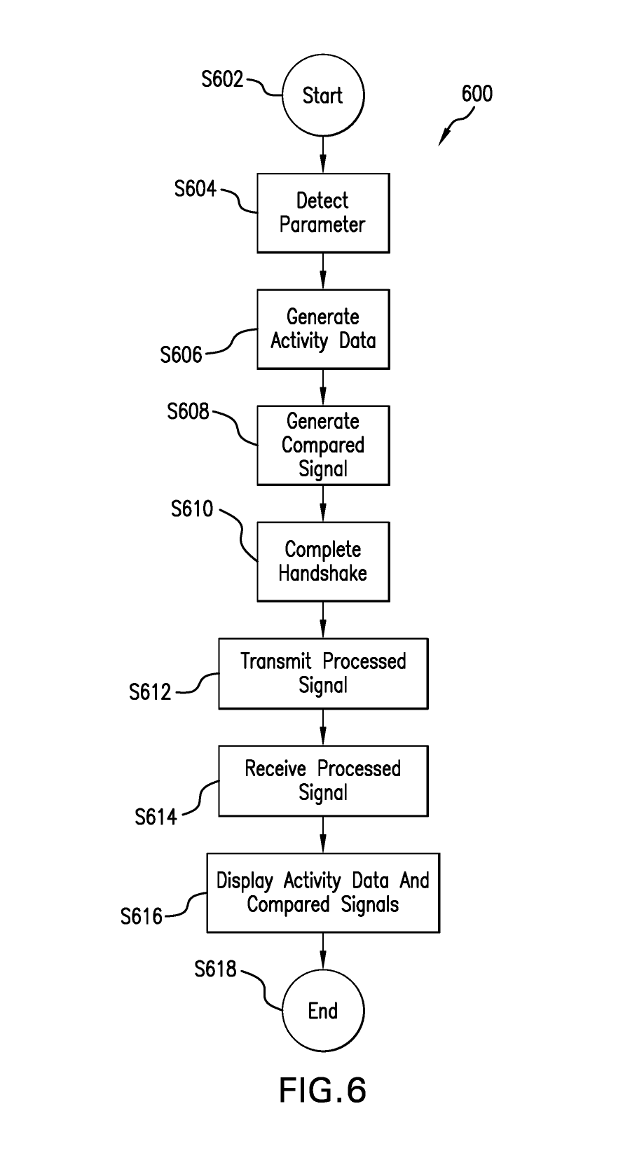

Throughout the game, activity tracking shoe 106 worn by the player captures data regarding the playing activity of the player. The process by which the activity data is detected, generated, compared, and displayed will be further described with reference to FIG. 6.

FIG. 6 illustrates a method by which basketball activities are detected, generated, transmitted, and displayed.

As shown in the figure, method 600 starts (S602) and parameters are detected (S604).

Returning to FIGS. 3 and 4A, when player 402 and player 404 begin to play, timer 302 starts and begins to track the amount of time elapsed during play. Because the activity of player 404 will be tracked in a manner equivalent to that of player 402, only the activity of player 402 will be described. When timer 302 starts, positioning component 304 also starts tracking the position of player 402 during play. Timer 302 and positioning component 304 provide the time and geodetic location data to controlling component 306. Timer 302 may be programmed to record activity for a predetermined amount of time. For example, timer 302 may be programmed before the start of a 2-hour practice to record activity levels for the entire two hours.

Returning to FIG. 6, after the parameter is detected (S604), activity data is generated (S606).

Referring back to FIG. 3, controlling component 306 receives the timing and geodetic location data and generates activity data based on the timing and geodetic location data. For example, and returning to FIGS. 4A-C, the activity data may show that, during practice, player 402 had a maximum speed of 22 feet per second (ft/s), an average speed of 15 ft/s, and a maximum acceleration of 40 feet per second squared (ft/s²). Other non-limiting examples of activity data include activity data, which indicates that player 402 traveled a total distance of 3,000 feet, and activity data, which indicates that he was moving during 80% of the time recorded.

Returning to FIG. 5, another non-limiting example of activity data includes activity data, which indicates that player 402 spends 80% in around spot 516. Such information may be useful for a coach that desires a player having a more motion-based style of play. Another non-limiting example of activity data includes activity data, which indicates that player 402 has a relatively low average velocity when traveling from the offensive end of the court to defensive end of the court. Such information may be useful for a coach that desires a player hustles to get back on defense. Any type of style of play that is based on time and position may be tracked and analyzed in accordance with aspects of the present invention.

Returning to FIG. 3, controlling component 306 then provides the generated activity data to memory 308 to store activity data.

Returning to FIG. 6, after the activity data is generated (S606), a compared signal is generated (S608).

Referring back to FIG. 3, memory 308 provides the generated activity data to comparator 312, and comparator 312 generates a compared signal. The compared signal may be based on a comparison of the generated activity data and the a priori data pre-loaded in memory 308, but it may also be based on a comparison of the generated activity data of more than one player during the same practice or game.

Referring to FIG. 5, in some embodiments, the generated activity data for the player may be compared to the a priori data in memory 308 to compare the player's performance to the a priori data for poor, average, and excellent players. Such comparison may be provided for many styles of play. For example, based on the generated activity data, the player may be indicated as a poor hustler when returning to defense, an average player when returning to offense and an excellent player with respect to the amount of motion on the offensive side of the court. In other embodiments, a composite rating may be provided that includes some combination of all the generated activity data. For example, based on the generated activity data, the player may be indicated as an average player with respect to all activity data.

In some embodiments, the generated activity data for the player may be compared to the a priori data in memory 308 to rank the player's performance to the a priori data of players. Such ranking may be provided for many styles of play. For example, based on the generated activity data, the player may be indicated as a the sixth best hustler when returning to defense, the third fastest player when returning to offense and the most in-motion player with respect to the amount of motion on the offensive side of the court. In other embodiments, a composite ranking may be provided that includes some combination of all the generated activity data. For example, based on the generated activity data, the player may be ranked as the third best player with respect to all activity data.

Returning to FIGS. 4A-C, the compared signal may be based on a comparison of the activity levels of player 402 and player 404, or it may be based on a comparison of the average of the total activity levels of player 402 and player 404.

Returning to FIG. 6, after the compared signal is generated (S608), a handshake is completed (S610).

Referring back to FIG. 2, after the practice or game has concluded, a player or coach can then view the activity levels. To view activity levels, shoe 106 must be paired with computing device 204 by initiating a handshake between the two devices. A successful handshake between shoe 106 and computing device 204 will assure an open communication channel can be established before attempting to send any data over the communication channel. The handshake between shoe 106 and computing device 204 may occur via any known method of handshaking that effectively opens communication between two devices. Non-limiting examples of methods of handshaking include those performed via Wi-Fi, Bluetooth, a cellular network signal, or any combination thereof.

Returning to FIG. 6, after the handshake is completed (S610), the processed signal is transmitted (S612).

Referring back to FIG. 3, processing component 310 receives the compared signal from comparator 312 and the activity data from memory 308. Processing component 310 generates a processed signal based on the compared signal and the activity data, and processing component 310 transmits the processed signal to computing device 204.

Returning to FIG. 6, after the processed signal is transmitted (S612), the processed signal is received (S614).

Referring to FIG. 2B, receiver 206 of computing device 204 receives the processed signal and provides the processed signal to processing component 208. Processing component 208 further processes the processed signal to create a display signal that is provided to GUI 210.

Returning to FIG. 6, after the processed signal is received (S614), the activity data and comparison data is displayed (S616).

Referring to FIGS. 2A-B, GUI 210 displays the activity data and comparison data on the screen of computing device 204. The user may view the raw activity data for one or more players, or the user may view the comparison data to view how a certain player compares to an average or excellent player.

Returning to FIG. 6, method 600 ends (S618).

The embodiments of the activity monitoring system described above have many different applications. A coach may choose to use the system to determine a player's strengths and weaknesses in order to develop practice and training plans to help the player improve. For example, after examining the raw activity data the coach may find that the player moves faster to his left than his right, or that he jumps higher when he jumps off two feet than when he jumps off one foot, or that he has difficulty shooting from the right side of the court when he is fatigued. The coach may then develop specific training plans to address the player's weaknesses.

The coach may also choose to use the system to provide data related to the movement of the entire team during practice or a game. This data may help the coach put players in different positions to better execute the offensive or defensive schemes.

The coach may also choose to use the system to provide data related to a specific matchup between players. With reference to FIGS. 4A-C, the coach may desire to analyze the relative spacing between player 402 and player 404 during a one-on-one game in order to better understand how each player positions himself on defense.

In some embodiments, there may be an application installed on a mobile device that communicates with pod 202. The application may include a training mode in which it challenges a player to complete certain skills to improve his overall game. For example, the application may include a “quick feet” drill, where the player must move his feet up and down very quickly over a specified amount of time. The application may store the player's results over time so the player can check his progress and determine if he is improving.

As another example, a scout looking to determine whether he should offer a player a scholarship may use the system to determine a player's overall playing style. For example, and with reference to FIG. 5, the scout may have players perform multiple skills on the court, moving between all the spots on the court at various times while dribbling, sprinting, backpedaling, and shuffling. He may find that player A has superior quickness when moving laterally, but has only average quickness when moving forward and backward. The scout may also find that player B is always in motion, whereas player A has a tendency to move less frequently when he does not have the ball. If the scout is looking for a player with a lot of energy that is in constant motion, then he may take a closer look at player B but disregard player A.

In yet another example, pod 202 may be paired with another device a player wears on his wrist during a game or a practice. Pairing multiple devices may provide even richer data by correlating the activities based on foot movement with the activities based on wrist movement. Examples of activities based on wrist movement include dribbling, shooting, passing, having active hands while playing defense, blocked shots, and rebounds.

In the above-discusses example embodiments, a smart shoe detects parameters of a wearer in order to analyze a style of play. This is a non-limiting example embodiment. In other embodiments, other smart wearables may be used, non-limiting examples of which include smart head bands, smart arm bands and combinations thereof.

In summary, the activity tracking device and method provides the ability to track the activity of a single player or a group of players while playing basketball. A shoe with a specialized activity pod transmits activity data to a computing device, from which the players, coach, or other interested party may view the data. The raw data may be viewed to better understand the player's absolute performance. In addition, the raw data may be compared to pre-loaded data to better understand the player's relative performance.

The foregoing description of various preferred embodiments have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A system comprising:
a shoe;
a timer disposed at said shoe and being operable to establish a time frame;
a positioning component disposed at said shoe and being operable to determine a first geodetic location of said shoe at a first time within the time frame and to determine a second geodetic location of said shoe at a second time within the time frame;
a controlling component disposed at said shoe and being operable to generate activity data based on the first geodetic location, the second geodetic location and the time frame;
a memory disposed at said shoe and being operable to store the activity data; and
a processing component operable to retrieve the activity data from said memory and to wirelessly transmit processed activity data based on the activity data,
wherein said positioning component is further operable to determine a first geodetic location total time corresponding to a total time said shoe is located at said first geodetic location within the time frame.

2. The system of claim 1, further comprising:
a second shoe;
a second positioning component disposed at said second shoe and being operable to determine a third geodetic location of said second shoe at the first time and to determine a fourth geodetic location of said second shoe at the second time;
a second controlling component disposed at said second shoe and being operable to generate second activity data based on the third geodetic location, the first time, the fourth geodetic location and the second time; and
a second memory disposed at said second shoe and being operable to store the second activity data,
wherein said processing component is disposed at said shoe, is further operable to wirelessly retrieve the second activity data from said second memory, and is further operable to wireless transmit the processed activity data additionally based on the second activity data.

3. The system of claim 2, further comprising:
a comparator,
wherein said memory has a priori data stored therein, the a priori data including data corresponding to one of the group consisting of total movement time, average velocity, maximum velocity, total distance traveled, maximum acceleration, time in air, ground contact time and combinations thereof,
wherein said comparator is operable to generate a compared signal based on the processed activity data and a portion of the a priori data.

4. The system of claim 3, wherein the a priori data includes data additionally corresponding to directional total movement time, directional average velocity, directional maximum velocity, directional total distance traveled, directional maximum acceleration and combinations thereof.

5. The system of claim 1, further comprising:
a comparator,
wherein said memory has a priori data stored therein, the a priori data including data corresponding to one of the group consisting of total movement time, average velocity, maximum velocity, total distance traveled, maximum acceleration, time in air, ground contact time and combinations thereof,
wherein said comparator is operable to generate a compared signal based on the processed activity data and a portion of the a priori data.

6. The system of claim 5, wherein the a priori data includes data additionally corresponding to directional total movement time, directional average velocity, directional maximum velocity, directional total distance traveled, directional maximum acceleration and combinations thereof.

7. A system for use with a shoe and a second shoe, the first shoe having a first pod disposed therein, the first pod including a timer, a positioning component, a controlling component, a memory and a processing component, the timer being operable to establish a time frame, the positioning component being operable to determine a first geodetic location of the first shoe at a first time within the time frame and to determine a second geodetic location of the first shoe at a second time within the time frame, the controlling component being operable to generate activity data based on the first geodetic location, the second geodetic location and the time frame, the memory being operable to store the activity data, the processing component being operable to retrieve the first activity data from the memory and to wirelessly transmit processed activity data based on the first activity data, the positioning component being further operable to determine a first geodetic location total time corresponding to a total time the shoe is located at the first geodetic location within the time frame, the second shoe having a second pod disposed therein, the second pod including a second timer, a second positioning component, a second controlling component, a second memory and a second processing component, the second timer being operable to establish a second time frame, the second positioning component being operable to determine a third geodetic location of the second shoe at a third time within the second time frame and to determine a fourth geodetic location of the second shoe at a fourth time within the second time frame, the second controlling component being operable to generate second activity data based on the third geodetic location, the fourth geodetic location and the second time frame, the second memory being operable to store the second activity data, the second processing component being operable to retrieve the second activity data from the second memory and to wirelessly transmit second processed activity data based on the second activity data, the second positioning component being further operable to determine a second geodetic location total time corresponding to a second total time the second shoe is located at the third geodetic location within the second time frame, said system comprising:
a receiver operable to wirelessly receive the processed activity data from the processing component and to wirelessly receive the second processed activity data from the second processing component;
a processing component operable to output first shoe data corresponding to the processed activity data relative to the second processed activity data; and
a graphic user interface portion operable to generate a graphic user interface to display the first shoe data.
